(19) United States
(12) Patent Application Publication
(10) Pub. No.: US 2020/0240812 A1
(43) Pub. Date: Jul. 30, 2020

(54) ELECTROMAGNETIC INDUCTION TYPE ENCODER

(71) Applicant: Mitutoyo Corporation, Kawasaki (JP)

(72) Inventor: Hiroto Kubozono, Kanagawa (JP)

(21) Appl. No.: 16/746,144

(22) Filed: Jan. 17, 2020

(30) Foreign Application Priority Data
Jan. 29, 2019 (JP) 2019-013084

(51) Int. Cl. G01D 5/20; G01D 5/249; G01D 5/245

(52) U.S. Cl. CPC G01D 5/2073; G01D 5/245; G01D 5/2053; G01D 5/2497

(57) ABSTRACT

The electromagnetic induction type encoder includes a detection head and a scale each having a substantially flat plate shape. The detection head and the scale are disposed opposed to one another and relatively move in a measurement axis direction. The scale includes a plurality of periodic elements formed of a conductor periodically disposed in the measurement axis direction. The plurality of periodic elements are coupled with a conductor. The detection head includes a transmitting coil wired so as to generate two or more eddy currents in directions opposite to one another in each of the plurality of periodic elements. The detection head includes a receiving coil. The receiving coil is electromagnetically coupled to magnetic fluxes generated by the plurality of periodic elements to detect phases of the magnetic fluxes.

### TECHNICAL FIELD

The present invention relates to an electromagnetic induction type encoder.

### BACKGROUND ART

An electromagnetic induction type encoder utilizing electromagnetic coupling between a detection head and a scale (see, for example, Patent Document 1) has been known.

### CITATION LIST

### Patent Literature

Patent Document 1: JP 2000-180209 A

### SUMMARY OF INVENTION

### Technical Problem

In the electromagnetic induction type encoder with multiple tracks on the scale, an unintended signal is possibly input from a track adjacent to a track being focused. Since the unintended signal causes false detection, sufficiently separating a distance between the tracks is considered to reduce an influence between the tracks. However, when the electromagnetic induction type encoder is attempted to reduce in size, the distance between the tracks cannot be sufficiently ensured possibly.

According to one aspect, an object of the invention is to provide an electromagnetic induction type encoder that can suppress an influence between tracks.

### Solution to Problem

In one aspect, an electromagnetic induction type encoder according to the invention includes a detection head and a scale each having a substantially flat plate shape. The detection head and the scale are disposed opposed to one another and relatively move in a measurement axis direction. The scale includes a plurality of periodic elements formed of a conductor periodically disposed in the measurement axis direction. The plurality of periodic elements are coupled with a conductor. The detection head includes a transmitting coil wired so as to generate two or more eddy currents in directions opposite to one another in each of the plurality of periodic elements. The detection head includes a receiving coil. The receiving coil is electromagnetically coupled to magnetic fluxes generated by the plurality of periodic elements to detect phases of the magnetic fluxes.

In the above-described electromagnetic induction type encoder, the scale may be a conductor having the flat plate shape. The scale may have a structure in which a plurality of through-holes are formed in the measurement axis direction.

In the above-described electromagnetic induction type encoder, the periodic elements may be conductor parts between the two adjacent through-holes among the plurality of through-holes.

In the above-described electromagnetic induction type encoder, the periodic elements may be conductor parts surrounding the two adjacent through-holes among the plurality of through-holes.

In the above-described electromagnetic induction type encoder, the receiving coil may include two or more coils. The two or more coils are configured to detect the respective two or more eddy currents.

In the above magnetic-electromagnetic induction type encoder, the transmitting coil may have a twisted structure in which two rectangular coils having length directions in the measurement axis direction are arranged and are wired such that currents flow in the respective rectangular coils in opposite directions.

### Advantageous Effects of Invention

The electromagnetic induction type encoder that can suppress an influence between the tracks can be provided.

### BRIEF DESCRIPTION OF DRAWINGS

FIG. 1A is a diagram illustrating an example of a detection head according to a comparative configuration, and FIG. 1B is a diagram illustrating an example of a scale according to the comparative configuration.

FIG. 2 is a diagram illustrating an example of flows of currents.

FIG. 3A is a diagram illustrating an example of a detection head according to a first embodiment, and FIG. 3B is a diagram illustrating an example of a scale according to the first embodiment.

FIG. 4 is a diagram illustrating an example of flows of currents on the scale when the current is flown through a transmitting coil.

FIGS. 5A to 5C are diagrams illustrating examples of structures of the scale.

FIGS. 6A to 6D are diagrams for explaining an electromagnetic induction type encoder according to a second embodiment.

FIGS. 7A to 7E are diagrams for explaining an electromagnetic induction type encoder according to a third embodiment.

### DESCRIPTION OF EMBODIMENTS

### Comparative Configuration

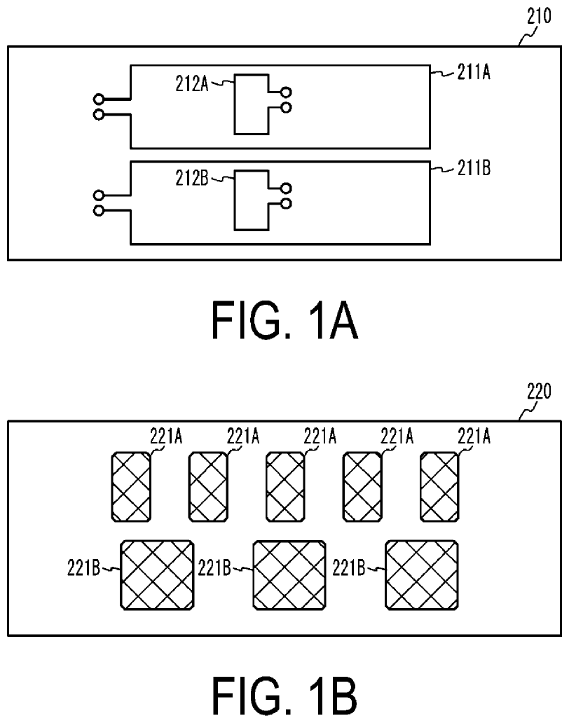

Prior to a description of embodiments, a comparative configuration will be described. FIGS. 1A and 1B are diagrams for explaining an electromagnetic induction type encoder according to the comparative configuration. FIG. 1A is a diagram illustrating an example of a detection head 210. FIG. 1B is a diagram illustrating an example of a scale 220. The detection head 210 and the scale 220 each have a substantially flat plate shape and are disposed opposed to one another via a predetermined gap.

As illustrated in FIG. 1A as an example, the detection head 210 includes, for example, a transmitting coil 211A and a receiving coil 212A for a track A. The transmitting coil 211A constitutes a rectangular coil. The receiving coil 212A is disposed inside the transmitting coil 211A.

As illustrated in FIG. 1B as an example, in the scale 220, a plurality of conductors 221A having a rectangular shape are arranged for the track A at fundamental periods λA along a measurement axis. The respective conductors 221A are separated from one another and are insulated from one another. The conductors 221A are each electromagnetically coupled to the transmitting coil 211A and are electromagnetically coupled to the receiving coil 212A.

The detection head 210 includes, for example, a transmitting coil 211B and a receiving coil 212B for a track B. The transmitting coil 211B and the receiving coil 212B have configurations similar to the transmitting coil 211A and the receiving coil 212A. In the scale 220, a plurality of conductors 221B having a rectangular shape are arranged for the track B at fundamental periods λB along the measurement axis.

When a signal of the track A is desired to be obtained, a current is flown through the transmitting coil 211A, and an electromotive force generated in the receiving coil 212A via the conductors 221A is measured. Ideally, the receiving coil 212A preferably detects only an influence due to eddy currents generated in the conductors 221A.

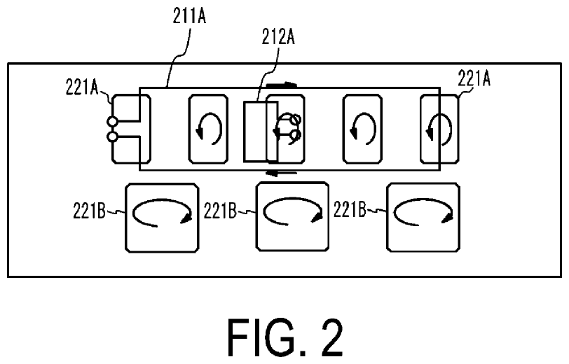

However, as illustrated in FIG. 2 as an example, flowing the current in the transmitting coil 211A generates eddy currents in the conductors 221B. Thus, the receiving coil 212A is also affected by the eddy currents in the conductors 221B. It is acceptable if the influence were uniform through the entire scale 220. However, since the track A and the track B differ in, for example, shapes and positions of the conductors, the influence from the track B becomes strong or weak depending on the scale position. Due to the change in influence, position detection accuracy of the electromagnetic induction type encoder becomes better or worse depending on the position. To suppress the variation in the position detection accuracy, increasing the space between the track A and the track B is considered. However, when attempting to decrease the size of the device, it is possible that a distance between the tracks cannot be sufficiently ensured.

In the following embodiments, an electromagnetic induction type encoder that can suppress an influence between the tracks will be described.

### First Embodiment

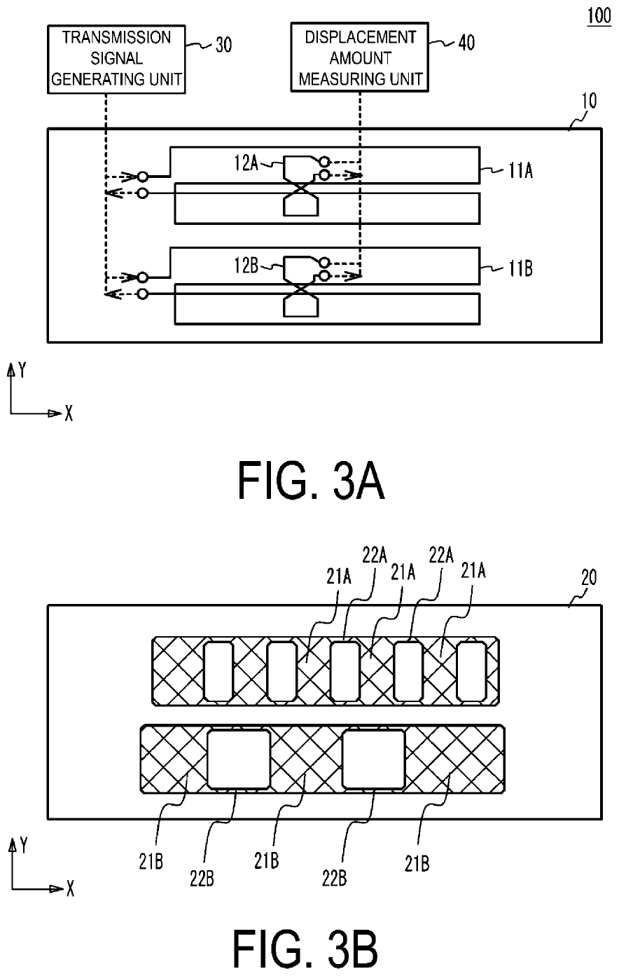

FIGS. 3A and 3B are diagrams for explaining an electromagnetic induction type encoder 100 according to the first embodiment. FIG. 3A is a diagram illustrating an example of a detection head 10. FIG. 3B is a diagram illustrating an example of a scale 20.

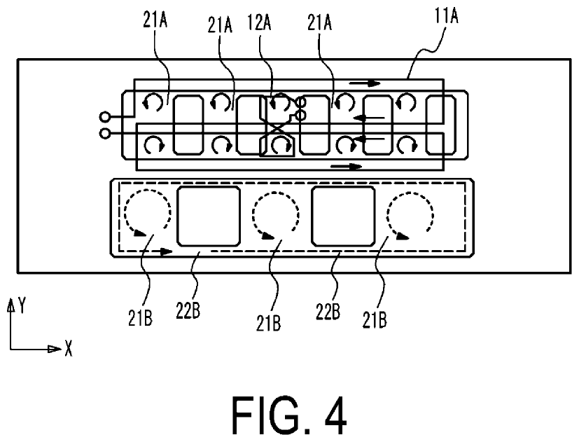

The electromagnetic induction type encoder 100 includes the detection head 10 and the scale 20 that relatively move in a measurement axis direction. The detection head 10 and the scale 20 each have a substantially flat plate shape and are disposed opposed to one another via a predetermined gap as illustrated in FIG. 4. Furthermore, the electromagnetic induction type encoder 100 includes, for example, a transmission signal generating unit 30 and a displacement amount measuring unit 40. In FIGS. 3A and 3B, an X-axis indicates a displacement direction (measurement axis) of the detection head 10. Note that, a direction orthogonal to the X-axis in a plane constituted by the scale 20 is defined as a Y-axis.

The detection head 10 includes, for example, a transmitting coil 11A and a receiving coil 12A for the track A. The transmitting coil 11A has a twisted structure in which two rectangular coils having a length direction in the X-axis direction are arranged in the Y-axis direction and are wired such that currents flow in the respective rectangular coils in opposite directions. In other words, the transmitting coil 11A includes two-stage coils. The receiving coil 12A has a twisted structure in which two coils are arranged in the Y-axis direction and are wired such that currents flow in the respective coils in opposite directions. One coil of the receiving coil 12A is disposed inside one rectangular coil of the transmitting coil 11A, and the other coil of the receiving coil 12A is disposed inside the other rectangular coil of the transmitting coil 11A.

The scale 20 has a structure in which a plurality of elements arranged at regular intervals are coupled to one another for the track A. In the example of FIG. 3B, the scale 20 has a structure in which a plurality of periodic elements 21A, which are conductors and have a rectangular shape, are arranged at the fundamental periods λA along the X-axis direction, and the periodic elements 21A are coupled with respective coupling portions 22A as conductors. The periodic elements 21A are each electromagnetically coupled to the transmitting coil 11A and is electromagnetically coupled to the receiving coil 12A. In the Y-axis direction, the coupling portion 22A has a width smaller than a width of the periodic element 21A. In the example in FIG. 3B, end portions in the Y-axis direction of the respective periodic elements 21A are coupled with the coupling portions 22A.

The detection head 10 includes, for example, a transmitting coil 11B and a receiving coil 12B for the track B. The transmitting coil 11B and the receiving coil 12B have configurations similar to the transmitting coil 11A and the receiving coil 12A. The scale 20 has a structure in which a plurality of elements arranged at regular intervals are coupled to one another for the track B. In the example of FIG. 3B, the scale 20 has a structure in which a plurality of periodic elements 21B, which are conductors and have a rectangular shape, are arranged at the fundamental periods λB along the X-axis direction, and the periodic elements 21B are coupled with respective coupling portions 22B as conductors. The periodic elements 21B are each electromagnetically coupled to the transmitting coil 11B and are electromagnetically coupled to the receiving coil 12B. In the Y-axis direction, the coupling portion 22B has a width smaller than a width of the periodic element 21B. The track A and the track B are disposed at a predetermined interval in the Y-axis direction. The fundamental period λA and the fundamental period λB may be different from one another. When the fundamental period λA and the fundamental period λB are the same, the positions of the periodic elements 21A and the periodic elements 21B in the X-axis direction may be different.

When a signal of the track A is desired to be obtained, the transmission signal generating unit 30 generates a single phase AC transmission signal and supplies the signal to the transmitting coil 11A. In this case, a magnetic flux is generated in the transmitting coil 11A. Thereby, an electromotive current is generated in the plurality of periodic elements 21A. The plurality of periodic elements 21A are electromagnetically coupled to the magnetic flux generated in the transmitting coil 11A to generate magnetic fluxes that change in the X-axis direction at a predetermined space period. The magnetic fluxes generated by the periodic elements 21A cause the receiving coil 12A to generate an electromotive current. The electromagnetic coupling between the respective coils changes according to a displacement amount of the detection head 10, and a sine wave signal with the same period as the fundamental period λA is obtained. Accordingly, the receiving coil 12A detects phases of the magnetic fluxes generated by the plurality of periodic elements 21A. The displacement amount measuring unit 40 can use the sine wave signal as a digital amount of the minimum resolution by electrically interpolating the sine wave signal and measure the displacement amount of the detection head 10.

For the track B as well, the transmission signal generating unit 30 supplies the transmission signal supplied to the track A to the transmitting coil 11B. When the fundamental period λA of the periodic elements 21A and the fundamental period λB of the periodic elements 21B are different, the electromagnetic induction type encoder 100 functions as an absolute type encoder.

FIG. 4 is a diagram illustrating an example of flows of currents on the scale 20 when the current is flown through the transmitting coil 11A. In each of the periodic elements 21B of the scale 20, an eddy current as indicated by the dotted line attempts to flow in a direction opposite to a flow of a current at a part closest to the track B in the transmitting coil 11A. However, in the present embodiment, since the respective periodic elements 21B are coupled to one another with the coupling portions 22B, a substantially uniform current as indicated by the dashed arrow flows through a wide range of a region in the track B of the scale 20. Thus, the state in which the influence from the track B becomes strong or weak depending on the scale position is reduced. That is, the influence between the tracks is suppressed. As a result, the measurement accuracy of the electromagnetic induction type encoder 100 is improved.

In the periodic element 21A, currents flowing in opposite directions occur at two different parts in the Y-axis direction. Specifically, in each periodic element 21A, the eddy currents in the directions opposite to one another occur at the positions corresponding to the respective rectangular coils of the transmitting coil 11A. Receiving the eddy currents at the respective coils of the receiving coil 12A allows detecting the signals. In this way, the eddy currents in the directions opposite to one another are generated at the respective parts displaced in the Y-axis direction in the region (conductive region) connected in the Y-axis direction. Accordingly, even when the respective periodic elements 21A are coupled to one another, the respective eddy currents are electromagnetically coupled to the respective coils of the receiving coil 12A, and thus the signals can be detected.

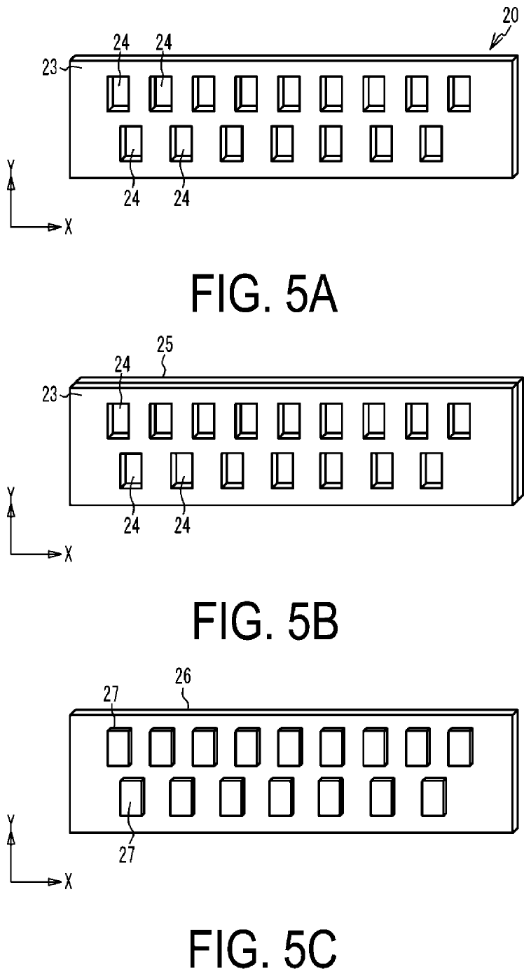

FIG. 5A is a diagram illustrating an example of the structure of the scale 20. As illustrated in FIG. 5A as an example, the scale 20 may have a structure in which a plurality of rectangular through-holes 24 are formed on a flat plate-shaped conductor 23 so as to be separated from one another along the X-axis direction. The formation of the through-holes 24 along the X-axis direction constitutes the track A. In the track A, parts between the two through-holes 24 function as the periodic elements 21A. The formation of rows of the plurality of through-holes 24 along the X-axis direction so as to be displaced in the Y-axis direction constitutes the track B. In the example of FIG. 5A, the periodic elements 21A and the periodic elements 21B are arranged at different fundamental periods.

As illustrated in FIG. 5C as an example, in a configuration in which a plurality of conductors 27 are pasted on a base material 26, a bonding step with, for example, an adhesive is required, and further positional accuracy may be problematic. In contrast, in the structure in the example of FIG. 5A, the through-holes 24 are formed in the integrally molded conductor 23. This eliminates the need for pasting the plurality of members together. As a result, the manufacturing process can be simplified, thereby ensuring cost reduction. Moreover, since an influence of the positional accuracy caused by the pasting does not occur, the reliability is improved. In addition, since the adjacent grids are connected together, strength is improved.

As illustrated in FIG. 5B as an example, the scale 20 may have a structure in which the conductor 23 of FIG. 5A is pasted to a base material 25. In this case, the strength is further enhanced.

### Second Embodiment

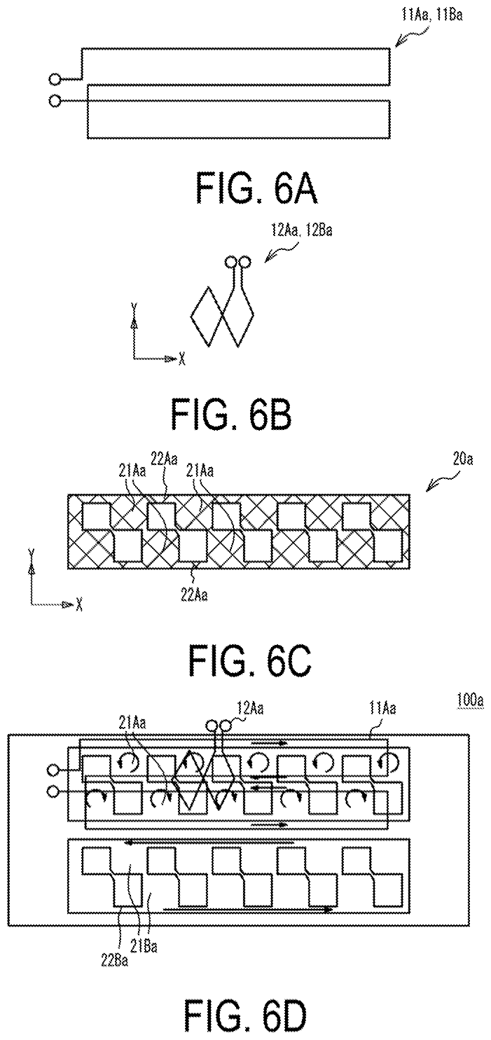

FIGS. 6A to 6D are diagrams for explaining an electromagnetic induction type encoder 100a according to the second embodiment. FIG. 6A is a diagram illustrating an example of a shape of a transmitting coil. FIG. 6B is a diagram illustrating an example of a shape of a receiving coil. FIG. 6C is a diagram illustrating an example of a shape of a scale. FIG. 6D is a diagram illustrating an example of directions of currents.

As illustrated in FIG. 6A as an example, in the second embodiment as well, shapes of transmitting coil 11Aa and 11Ba are similar to those of the first embodiment. The electromagnetic induction type encoder 100a differs from the electromagnetic induction type encoder 100 according to the first embodiment in that the shapes of the scale and the receiving coil are different.

As illustrated in FIG. 6B as an example, receiving coils 12Aa and 12Ba have a twisted structure in which two coils are arranged in the X-axis direction and are wired such that currents flow in the respective coils in opposite directions. Both coils of the receiving coil 12Aa extend over both rectangular coils of the transmitting coil 11Aa. Both coils of the receiving coil 12Ba extend over both rectangular coils of the transmitting coil 11Ba.

As illustrated in FIG. 6C as an example, periodic elements 21Aa do not have the rectangular shapes as illustrated in FIG. 3B but have shapes such that two rectangles disposed at different positions in the Y-axis direction are coupled by being displaced in the X-axis direction. A distance between centers of the two rectangles in the X-axis direction is substantially the same as a distance between centers of the two coils of the receiving coil 12Aa in the X-axis direction. With the periodic elements 21Aa having such shapes, in a case where one coil of the receiving coil 12Aa is positioned in one rectangle of the periodic element 21Aa, the other coil of the receiving coil 12Aa is positioned in the other rectangle of the periodic element 21Aa. The respective periodic elements 21Aa are coupled with coupling portions 22Aa as conductors. In the Y-axis direction, the coupling portion 22Aa has a width smaller than a width of the periodic element 21Aa. In the example in FIG. 6C, end portions in the Y-axis direction of the respective periodic elements 21Aa are coupled with the coupling portions 22Aa.

For the track B, periodic elements 21Ba and coupling portions 22Ba have the same structure as the periodic elements 21Aa and the coupling portions 22Aa. A fundamental period of the periodic elements 21A and a fundamental period of the periodic elements 21Ba may be the same or different similarly to the first embodiment.

When the transmission signal generating unit 30 supplies a single phase AC transmission signal to the transmitting coil 11Aa, a magnetic flux is generated in the transmitting coil 11Aa. Thereby, an electromotive current is generated in the plurality of periodic elements 21Aa. As illustrated in FIG. 6D as an example, in each of the periodic elements 21Ba of a scale 20a, an eddy current attempts to flow in a direction opposite to a flow of a current at a part closest to the track B in the transmitting coil 11Aa. However, in the present embodiment, since the respective periodic elements 21Ba are coupled to one another with the coupling portions 22Ba, a substantially uniform current flows through a wide range of a region in the track B of the scale 20a. Thus, the state in which the influence from the track B becomes strong or weak depending on the scale position is reduced. That is, the influence between the tracks is suppressed. As a result, the measurement accuracy of the electromagnetic induction type encoder 100a is improved.

In the periodic element 21Aa, currents flowing in opposite directions occur in each rectangular region. Specifically, in each periodic element 21Aa, the eddy currents in the directions opposite to one another occur at the positions corresponding to the respective rectangular coils of the transmitting coil 11Aa. Receiving the eddy currents at the respective coils of the receiving coil 12Aa allows detecting the signals. In this way, the eddy currents in the directions opposite to one another are generated at the respective parts displaced in the Y-axis direction in the region connected in the Y-axis direction. Accordingly, even when the respective periodic elements 21Aa are coupled to one another, the respective eddy currents are electromagnetically coupled to the respective coils of the receiving coil 12Aa, and thus the signals can be detected.

### Third Embodiment

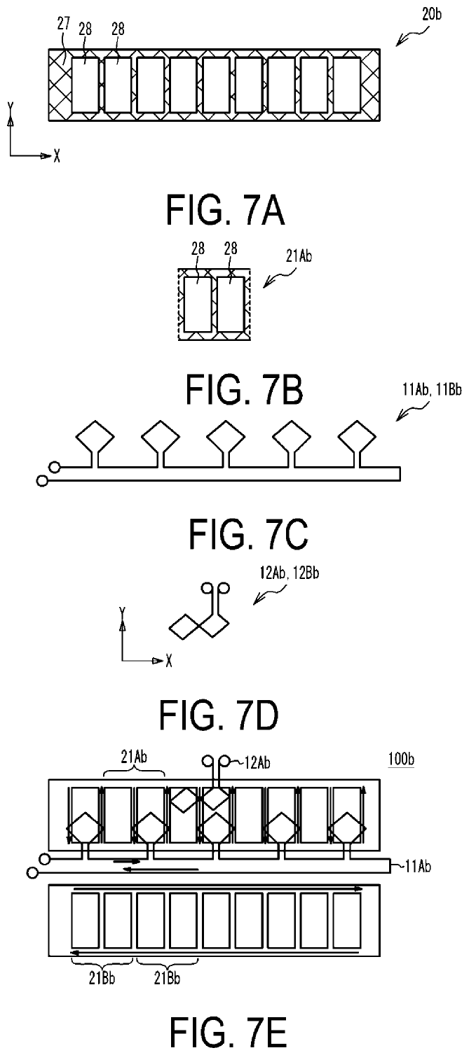

FIGS. 7A to 7E are diagrams for explaining an electromagnetic induction type encoder 100b according to the third embodiment. FIG. 7A is a diagram illustrating an example of a shape of a scale. FIG. 7B is a diagram illustrating an example of a shape of each periodic element. FIG. 7C is a diagram illustrating an example of a shape of a transmitting coil. FIG. 7D is a diagram illustrating an example of a shape of a receiving coil. FIG. 7E is a diagram illustrating an example of directions of currents.

As illustrated in FIG. 7A as an example, a scale 20b has a structure in which a plurality of rectangular through-holes 28 are formed on a flat plate-shaped conductor 27 so as to be separated from one another along the X-axis direction. In this configuration, as illustrated in FIG. 7B as an example, the track A includes a periodic element 21Ab configured of the two through-holes 28 and a conductor part surrounding the two through-holes. The respective periodic elements 21Ab are coupled to one another to obtain the structure of FIG. 7A. For the track B, periodic elements 21Bb have the same structure as the periodic elements 21Ab. A fundamental period of the periodic elements 21Ab and a fundamental period of the periodic elements 21Bb may be the same or different similarly to the first embodiment.

As illustrated in FIG. 7C as an example, a transmitting coil 11Ab has a wiring structure in which coils are arranged at a double pitch of the through-holes 28, and the respective coils are coupled so that directions of currents in the respective coils become the same.

As illustrated in FIG. 7D as an example, receiving coils 12Ab and 12Bb have a twisted structure in which two coils are arranged in the X-axis direction and are wired such that currents flow in the respective coils in opposite directions. The pitches of the respective coils of the receiving coils 12Ab and 12Bb are set equal to the pitches of the respective through-holes 28 in the scale. In a case where one coil of the receiving coil 12Ab is positioned in one rectangle of the periodic element 21Ab, the other coil of the receiving coil 12Ab is positioned in the other rectangle of the periodic element 21Ab.

When the transmission signal generating unit 30 supplies a single phase AC transmission signal to the transmitting coil 11Ab, a magnetic flux is generated in the transmitting coil 11Ab. Thereby, an electromotive current is generated in the plurality of periodic elements 21Ab. As illustrated in FIG. 7E as an example, in each of the periodic elements 21Bb of the scale 20b, an eddy current attempts to flow in a direction opposite to a flow of a current at a part closest to the track B in the transmitting coil 11Ab. However, in the present embodiment, since the respective periodic elements 21Bb are coupled to one another, a substantially uniform current flows through a wide range of a region in the track B of the scale 20b. Thus, the state in which the influence from the track B becomes strong or weak depending on the scale position is reduced. That is, the influence between the tracks is suppressed. As a result, the measurement accuracy of the electromagnetic induction type encoder 100b is improved.

In the periodic element 21Ab, currents flowing in opposite directions occur in each rectangular region. Specifically, in each periodic element 21Ab, the eddy currents in the directions opposite to one another occur at the positions corresponding to the respective rectangular coils of the transmitting coil 11Ab. Receiving the eddy currents at the respective coils of the receiving coil 12Ab allows detecting the signals. In this way, the eddy currents in the directions opposite to one another are generated at the respective parts displaced in the X-axis direction in the region connected in the X-axis direction. Accordingly, even when the respective periodic elements 21Ab are coupled to one another, the respective eddy currents are electromagnetically coupled to the respective coils of the receiving coil 12Ab, and thus the signals can be detected.

Although the embodiments and examples according to the invention have been described above, it is to be understood that the invention is not limited to the specific embodiments and examples and that various changes and modifications may be made in the invention within the scope of the invention described in the claims.

### REFERENCE SIGNS LIST

10 Detection head
11 Transmitting coil
12 Receiving coil
20 Scale
21 Periodic element
22 Coupling portion
23 Conductor
24 Through-hole
25 Base material
26 Base material
27 Conductor
30 Transmission signal generating unit
40 Displacement amount measuring unit
100 Electromagnetic induction type encoder

1. An electromagnetic induction type encoder comprising:
a detection head and a scale each having a substantially flat plate shape, the detection head and the scale being disposed opposed to one another and relatively moving in a measurement axis direction, wherein
the scale includes a plurality of periodic elements formed of a conductor periodically disposed in the measurement axis direction,
the plurality of periodic elements are coupled with a conductor,
the detection head includes a transmitting coil wired so as to generate two or more eddy currents in directions opposite to one another in each of the plurality of periodic elements, and
the detection head includes a receiving coil, the receiving coil being electromagnetically coupled to magnetic fluxes generated by the plurality of periodic elements to detect phases of the magnetic fluxes.

2. The electromagnetic induction type encoder according to claim 1, wherein
the scale is a conductor having the flat plate shape, the scale having a structure in which a plurality of through-holes are formed in the measurement axis direction.

3. The electromagnetic induction type encoder according to claim 2, wherein
the periodic elements are conductor parts between the two adjacent through-holes among the plurality of through-holes.

4. The electromagnetic induction type encoder according to claim 2, wherein
the periodic elements are conductor parts surrounding the two adjacent through-holes among the plurality of through-holes.

5. The electromagnetic induction type encoder according to claim 1, wherein
the receiving coil includes two or more coils, the two or more coils being configured to detect the respective two or more eddy currents.

6. The electromagnetic induction type encoder according to claim 1, wherein
the transmitting coil has a twisted structure in which two rectangular coils having length directions in the measurement axis direction are arranged and are wired such that currents flow in the respective rectangular coils in opposite directions.
